(19) United States
(12) Patent Application Publication
(10) Pub. No.: US 2024/0147974 A1
(43) Pub. Date: May 9, 2024

(54) PROPELLER JIGGING SPOON LURES

(71) Applicants: Alex Peric, Krum, TX (US); Aaron Wiebe, Lac Du Bonnet (CA)

(72) Inventors: Alex Peric, Krum, TX (US); Aaron Wiebe, Lac Du Bonnet (CA)

(21) Appl. No.: 18/501,514

(22) Filed: Nov. 3, 2023

Related U.S. Application Data
(60) Provisional application No. 63/422,726, filed on Nov. 4, 2022.

(51) Int. Cl. A01K 85/14

(52) U.S. Cl. CPC A01K 85/14

(57) ABSTRACT

Fishing lures of the jigging spoon type are disclosed. Exemplary jigging spoon lures may include a body of heavy material, a propeller or blade at each end of the body, and a through wire on which the propellers are mounted. A hook, which may be a treble hook, is at one end of the lure and a line tie is at the other end of the lure. Rattles may be included in the body.

### CROSS-REFERENCE TO RELATED APPLICATION(S)

This application claims priority to U.S. Provisional Patent Application No. 63/422,726 filed on Nov. 4, 2022, the entire contents of which are incorporated herein by reference.

### FIELD OF DISCLOSURE

The instant disclosure relates to fishing lures. More particularly, exemplary fishing lures are of the type commonly called a jigging spoon including the slab spoon style.

### INTRODUCTION

Fishing lures come in various sizes, shapes, and colors. Various lures utilize different features to attract the attention of fish.

### SUMMARY

Considered broadly, jigging spoons have a line tie, a substantially heavy and flat body, and a hook. Slab spoons achieve additional mass by adding width to the body of the spoon. In exemplary embodiments, the body may comprise lead, tungsten, a tungsten alloy, or injection molded plastic. Current applications of jigging spoons utilize rattles for appealing to the sense of sound, however slab spoon styles may have limited appeal to a fish's lateral lines.

In some aspects, the techniques described herein relate to a vertical style fishing lure, including: a body having a first end and a second end opposite the first end; a line tie adjacent the first end; a hook adjacent the second end; a first end propeller positioned between the first end and the line tie; and a second end propeller positioned between the second end and the hook.

In some aspects, the techniques described herein relate to a vertical jigging spoon lure, including: a body having a first end and a second end opposite the first end, the body having a density between 1 g/cm³ and 20 g/cm³; and the body including a rattle unit; a line tie adjacent the first end; a hook adjacent the second end; a first end propeller positioned between the first end and the line tie; and a second end propeller positioned between the second end and the hook.

### BRIEF DESCRIPTION OF THE DRAWINGS

FIG. 1 is a cross section view of the front of an exemplary propeller jigging spoon, showing the propeller locations, rattles and through wire construction.

FIG. 2 is a top plan view of the exemplary propeller jigging spoon shown in FIG. 1.

FIG. 3 is a cross section view of the side of an exemplary propeller jigging spoon shown in FIG. 1, showing rattle locations and propeller diameter.

FIG. 4 shows exemplary propeller styles.

### DETAILED DESCRIPTION

The instant disclosure pertains generally to fishing lures. More specifically, jigging spoons. Jigging spoons are a common fishing lure style.

Instantly disclosed embodiments comprise propellers or blades above and below the lure body, which may result in increased fish attraction. Propellers are an attractant, providing a visible attraction as well as vibrations that are sensed by the fish's lateral line and otoliths. The addition of propellers or blades provides additional attraction for fish. Current applications of lures that utilize a propeller are specialized for casting or trolling, and are not applicable for a vertical presentation. One application has included a spinner type lure intended for a vertical presentation; however, the style of lure is intended for a cast and vertical drop presentation where the single propeller acts to stabilize and slow the lures drop speed.

Reverse chinned, or counter rotating propellers may help to maximize water movement, and minimize line twist from the body rotating. The propellers may be mounted onto a single through wire that supports the hook at one end, the line tie at the other end and acts as a spindle on which the propellers rotate. Multiple rattle chambers may maximize sound output. An asymmetric body shape may create a unique, erratic kicking action, shifting it from a vertical fall, to a 3 degree to 60 degree fall depending on jigging speed. A dense material body gives the lure sufficient weight to engage the propellers while the lure falls.

Exemplary embodiments disclosed herein may utilize multiple propellers, combined with rattles and an erratic drop to create additional attraction to fish while vertically jigging, especially ice fishing. A jigging spoon, particularly of the slab spoon style with propellers at each end and multiple rattles, creates additional attraction, appealing to multiple senses.

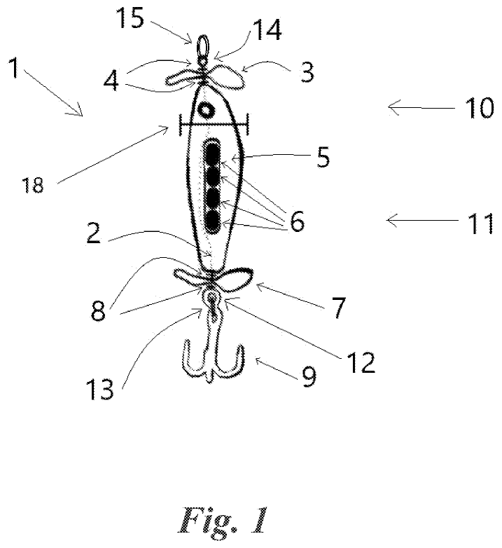

FIG. 1 shows an exemplary propeller jigging spoon lure 1. As shown, propeller jigging spoon lure 1 comprises a through wire 2 on which is mounted the top propeller 3, top washers 4, substantially heavy body 5 with rattles 6, bottom propeller 7, bottom washers 8, and hook 9. Other embodiments may include more or fewer components.

In some instances, the hook 9 is a treble hook style. In some implementations, one or more additional hooks may be mounted near a center of mass of the body 5.

The through wire 2 is formed so that there are loops at both the top end 10 and bottom end 11 of the propeller jigging spoon lure 1. The hook 9 is fastened to the bottom wire loop 12 with a split ring 13. The top wire loop 14 has a split ring 15 through it which acts as the line tie.

In some implementations, propeller jigging spoon lure 1 includes more than one top propeller 3. In some implementations, propeller jigging spoon lure 1 includes more than one bottom propeller 7. In some implementations, propeller jigging spoon lure 1 includes more than one top propeller 3 and more than one bottom propeller 7.

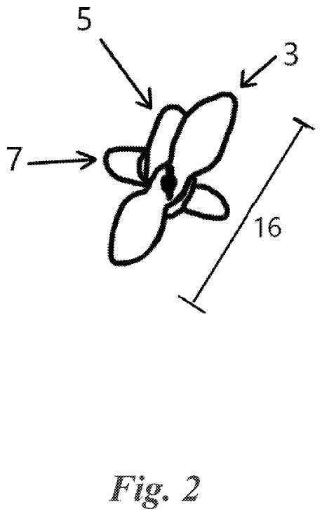

FIG. 2 shows a top view of the propeller jigging spoon lure 1. Propeller 3 and propeller 7 are in alignment vertically.

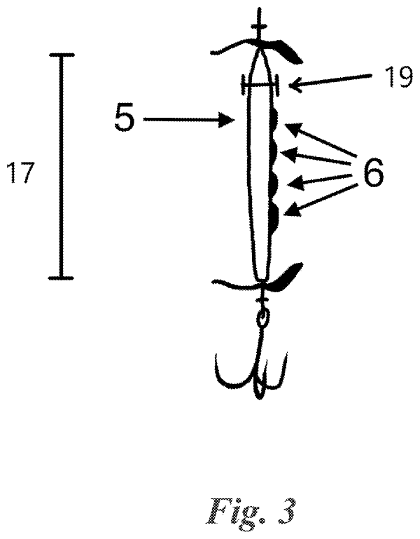

FIG. 3 shows the rattles 6 partially exposed from the substantially heavy body 5. Various types of rattles known in the art may be used for rattles 6.

In some instances, the body 5 may be made of a material having a density between 1 g/cm³ and 20 g/cm³; between 1 g/cm³ and 10 g/cm³; between 10 g/cm³ and 20 g/cm³; or between 5 g/cm³ and 15 g/cm³. In various implementations, the body 5 may be made of a material having a density of at least 1 g/cm³; at least 3 g/cm³; at least 5 g/cm³; at least 8 g/cm³; at least 10 g/cm³; at least 13 g/cm³; at least 15 g/cm³; or at least 19 g/cm³. In various implementations, the body 5 may be made of a material having a density of no greater than 20 g/cm³; no greater than 17 g/cm³; no greater than 14 g/cm³; no greater than 11 g/cm³; no greater than 8 g/cm³; no greater than 5 g/cm³; or no greater than 2 g/cm³. Exemplary materials that may be used for body 5 include, but are not limited to, lead, tungsten, tungsten alloy or injection molded plastic.

The propeller length may correlate to a length of the propeller jigging spoon lure 1. In some implementations, the propeller may be sized so that the propeller diameter 16 is 50%-65%; 50%-60%; 55%-65%; 53%-62%; or 60%-65% of the lure body length 17. In various instances, the propeller diameter may be at least 50%; at least 55%; at least 60%; or at least 65% of the lure body length. In various instances, the propeller diameter may no greater than 65%; no greater than 60%; no greater than 55%; or no greater than 50% of the lure body length.

The lure body width 18 may correlate to the lure body length 17. In some implementations, the width of the body 18 may be 22%-35%; 25%-32%; 22%-29%; 29%-35%; 28%-31%; or 24%-33% of the body length 17. In various instances, the width of the body 18 may be at least 22%; at least 25%; at least 28%; at least 31%; at least 33%; or at least 35% of the body length 17. In various instances, the width of the body 18 may be no greater than 35%; no greater than 32%; no greater than 29%; no greater than 24%; or no greater than 22% of the body length 17.

The thickness 19 of the lure may correlate to the lure body length 17. In some implementations, the thickness 19 of the lure may be 8%-18%; 8%-13%; 13%-18%; 8%-11%; 11%-14%; or 14%-18% of the lure body length 17. In various instances, the thickness 19 of the lure may be at least 8%; at least 11%; at least 14%; at least 16%; or at least 18% of the lure body length 17. In various instances, the thickness 19 of the lure may be no greater than 18%; no greater than 15%; no greater than 12%; no greater than 10%; or no greater than 8% of the lure body length 17.

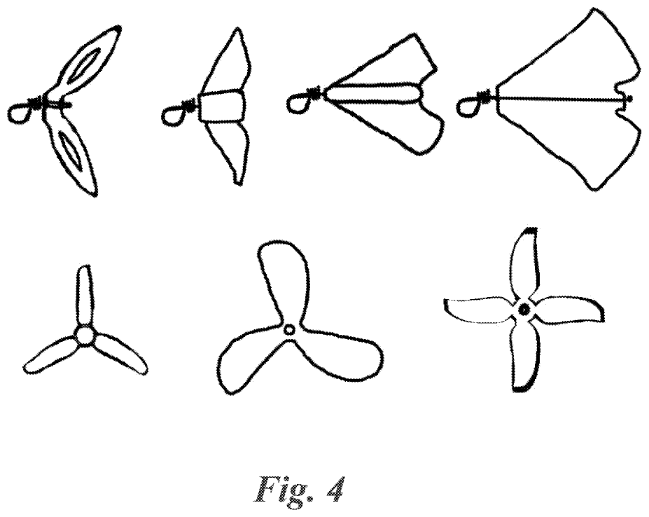

FIG. 4 shows exemplary propeller styles that may be used with the exemplary propeller jigging spoon lure shown in FIG. 1.

1. A vertical style fishing lure, comprising:
a body having a first end and a second end opposite the first end;
a line tie adjacent the first end;
a hook adjacent the second end;
a first end propeller positioned between the first end and the line tie; and
a second end propeller positioned between the second end and the hook.

2. The vertical style fishing lure according to claim 1, the body having a material density between 1 g/cm³ and 20 g/cm³.

3. The vertical style fishing lure according to claim 2, the body comprising tungsten or a tungsten alloy.

4. The vertical style fishing lure according to claim 2, the body comprising an injection molded material.

5. The vertical style fishing lure according to claim 1, the body further comprising at least one rattle unit.

6. The vertical style fishing lure according to claim 5, the body further comprising four rattle units.

7. The vertical style fishing lure according to claim 1, further comprising another first end propeller disposed between the first end propeller and the first end of the body.

8. The vertical style fishing lure according to claim 1, further comprising another second end propeller disposed between the second end propeller and the second end of the body.

9. The vertical style fishing lure according to claim 1, wherein each of the first end propeller and the second end propeller comprise 1-8 blades.

10. The vertical style fishing lure according to claim 1, wherein the first end propeller and the second end propeller are arranged to be counter rotating.

11. The vertical style fishing lure according to claim 1, further comprising a second hook mounted near a center of mass of the body.

12. The vertical style fishing lure according to claim 11, wherein the hook and/or the second hook are treble hooks.

13. The vertical style fishing lure according to claim 1, wherein the first end propeller has a diameter that is 50% to 65% of a length of the body.

14. The vertical style fishing lure according to claim 13, wherein a width of the body is 22% to 35% of the length of the body.

15. The vertical style fishing lure according to claim 14, wherein a thickness of the body is 8% to 18% of the length of the body.

16. The vertical style fishing lure according to claim 1, further comprising a through wire, where the line tie and the hook are connected to the through wire, and where the first end propeller, the body, and the second end propeller are mounted on the through wire.

17. A vertical jigging spoon lure, comprising:
a body having a first end and a second end opposite the first end,
the body having a density between 1 g/cm³ and 20 g/cm³; and
the body comprising a rattle unit;
a line tie adjacent the first end;
a hook adjacent the second end;
a first end propeller positioned between the first end and the line tie; and
a second end propeller positioned between the second end and the hook.

18. The vertical jigging spoon lure according to claim 17, the density of the body being between 10 g/cm³ and 20 g/cm³;
wherein the first end propeller has a diameter that is 50% to 65% of a length of the body; and
wherein the hook is a treble hook.

19. The vertical jigging spoon lure according to claim 18, the body comprising tungsten, tungsten alloy, or an injection molded material; and
the body comprising a plurality of rattle units.

20. The vertical jigging spoon lure according to claim 19, further comprising a through wire, where the line tie and the hook are connected to the through wire, and where the first end propeller, the body, and the second end propeller are mounted on the through wire,
wherein a width of the body is 22% to 35% of the length of the body;
wherein a thickness of the body is 8% to 18% of the length of the body; and
wherein the first end propeller and the second end propeller are arranged to be counter rotating.
